(19) United States
(12) Patent Application Publication
(10) Pub. No.: US 2017/0304663 A1
(43) Pub. Date: Oct. 26, 2017

(54) CONCEALED EXTENDABLE NOZZLE FOR GASEOUS FIRE SUPPRESSION SYSTEMS (VARIANTS)

(71) Applicant: "POJTEKHNIKA" LTD, Moscow (RU)

(72) Inventor: Natalya Viktorovna KHAZOVA, Moscow (RU)

(21) Appl. No.: 15/516,784

(22) PCT Filed: Mar. 11, 2016
(86) PCT No.: PCT/RU2016/000136

§ 371 Date: Apr. 4, 2017

(30) Foreign Application Priority Data
Mar. 11, 2015 (RU) 2015108390

(51) Int. Cl. A62C 31/02; B05B 1/00; A62C 99/00; B05B 15/10; A62C 3/00

(52) U.S. Cl. CPC A62C 31/02; B05B 15/10; A62C 3/00; A62C 99/0018; B05B 1/005

(57) ABSTRACT

The invention relates to a component of a gaseous fire suppression system. A concealed extendable nozzle for gaseous fire suppression systems is mounted on a distribution pipe of a gaseous fire suppression system. The nozzle consists of a body with discharge openings and a cap. A rod of a nipple is mounted inside the body of the nozzle. The nipple rod has a variable outside diameter: at one end, the rod narrows and ends in a connecting thread, whereas at the other end, the rod widens. Meanwhile, the body has an opening of variable diameter, which permits movement of the nipple rod inside the body; the body of the nozzle has a widening on the outside. A cap is fastened to the body of the nozzle, and this connection is tightly sealed by a washer. The technical result is the even dispersal of a gaseous fire extinguishant inside a room.

### CROSS-REFERENCE TO RELATED APPLICATIONS

The present application is the National stage application from PCT application PCT/RU2016/000136 filed Mar. 11, 2016 which claims priority to and incorporates fully by reference Russian application RU 2015108390 filed Mar. 11, 2015.

### FIELD OF INVENTION

The subject invention relates to fire fighting technical equipment, namely to an element of the gas fire extinguishing systems for fire suppression in the miscellaneous premises. The sprinkler is the device for discharge and distribution of gaseous fire extinguishing agent in the protected area.

### BACKGROUND

An analogue of the subject invention is the discharge sprinkler head mounted on the distribution pipeline of the automatic fire suppression system, containing the valve and the frangible bulb, characterized in that for putting the sprinkler into operation both as a result of temperature rise or overpressure in the distributive pipeline the hollow sleeve is secured on the discharge end of the sprinkler by means of the brackets, inside which there is the cap with the valve pressed to the sprinkler by the spring, the opposite end of which is supported by the rod with the frangible bulb (USSR Patent of Invention No 184625, dated of Jul. 21, 1966).

Disadvantage of the said device is that it is made as an integral part from workpiece, herein a spring wrapped around the rod loses original inflexibility affecting long-term, delayed and incomplete opening of an outlet port for fire agent discharge and reducing fire suppression efficiency.

The prototype of the subject technical decision is DESIGN OF THE SPRINKLER WITH FIRE EXTINGUISHER FOR FIRE SUPPRESSION. The design of the sprinkler for fast fire distribution disposal due to effective early fire suppression. The sprinkler design consists of: the sprinkler base (10) with the connecting block (11) above which the fire extinguisher (8) is installed, and a spray block (14) is placed in its lower part for dispersion of water or fire extinguishing agent from the pipe (12); and a cover (20) with metal snug which blocks nozzles and a block sheet (22); block heat conductivity (30) which includes radiation of plates (35a, 35b) and auxiliary radiation of a plate to improve heat conductivity (Korea Patent of Invention No KR101321825 (B1), dated of Oct. 23, 2013).

Disadvantage of the said device is the large-sized fire extinguisher excluding an opportunity of concealed installation of the device in the premises with false ceilings or technical ceiling voids. The cover makes necessary its removal by the user in case of fire, which is also disadvantage reducing fire suppression efficiency.

### SUMMARY

Technical result of the subject invention is achievement of high fire suppression efficiency due to uniform distribution of gas fire extinguishing agent in the room space under air compressed pressure in the pipeline, and the ready-to-work products discharge gas fire extinguishing agent in a protected area, and also an opportunity of concealed installation of the device in the premises with false ceilings or technical ceiling voids.

The said technical result is achieved due to the concealed extending sprinkler for gas fire suppression systems (Variant 1), mounted on the distributive pipe of the gas fire suppression system and consisting of the case with discharge outlets and a cover. Thus the nipple rod is installed in the sprinkler case, a groove in the nozzle case and in the nipple rod case is provided for O-ring sealing, the nipple rod is of variable OD (outer diameter), on the one side a rod is tapered and ended with a connection thread, on the other side it is extended, wherein in its turn the case has the opening of variable diameter providing moving a nipple rod inside the case, the sprinkler case is extended outside, a cover is secured to the sprinkler case, connection tightness between the cover and the sprinkler case is provided by a sealing gasket.

The concealed extending sprinkler for gas fire suppression systems (Variant 2), mounted on the distributive pipe of the gas fire suppression system and consisting of the case with discharge nozzles and a cover. Thus the nipple rod is installed in the sprinkler case, a groove in the nozzle case and in the nipple rod case is provided for O-ring sealing, the nipple rod is of variable OD (outer diameter), on the one side a rod is tapered and ended with a connection thread, on the other side it is extended, wherein in its turn the case has the opening of variable diameter for moving a nipple rod inside the case, a cover is secured to the sprinkler case for closing the nipple rod in the sprinkler case, thread in the cover is provided for connection to the distributive pipe of the gas fire suppression system, a protective cap is secured to the sprinkler case from opposite side, a sprinkler is secured to the connection thread of a nipple rod.

### BRIEF DESCRIPTION OF DRAWINGS

FIG. 1—main sectional view of the invention (variant 1) in closed (duty) position.

FIG. 2—main sectional view of the invention (variant 1) in extended (working) position.

FIG. 3—main sectional view of the invention (variant 2) in closed (duty) position.

FIG. 4—main sectional view of the invention (variant 2) in extended (working) position.

### DETAILED DESCRIPTION OF THE PREFERRED EMBODIMENT

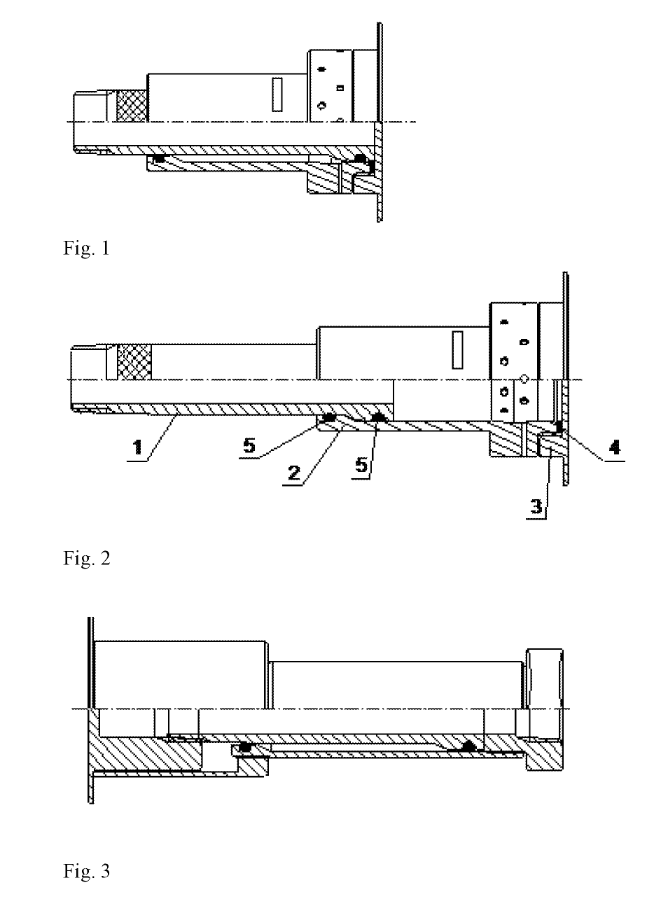

The subject invention (Variant 1, FIGS. 1, 2) includes the sprinkler case 2 in which the nipple rod 1 is installed. A groove for sealing O-ring 5 is in the sprinkler case 2 and in the nipple rod case 1. The sealing O-rings provide tightness and joint mobility the rod and the case relative to each other. The nipple rod is of variable outer diameter (OD). On the one side a rod is tapered and ended with a connection thread, on the other side it is extended that allows it to be blocked when moving to limit position. Wherein in its turn the case has the opening of variable diameter providing moving a nipple rod inside the case. The sprinkler case has external case widening with the drilled outlets. A cover 3 is secured to the sprinkler case, connection tightness between the cover and the sprinkler case is provided by a sealing gasket 4.

The device operates as follows.

The sprinkler in closed position is secured to the distributive pipe by means of connection thread on the nipple rod 1. In this position the nipple rod 1 is in end bottom position in the sprinkler case 2 and rests against the cover 3. Wherein the rod is kept in the closed position by means of the two sealing O-rings 6. The nipple in closed (duty) position blocks outlets of the sprinkler, creating hermetically sealed space. When the gas fire suppression system starts overpressure is generated in the distributive pipeline volume. Pressure rise inside the sprinkler results to moving the case 2 along the nipple rod 1 in lower limit position. Thus the sprinkler proceeds from closed (duty) position to extended (working) position. The sprinkler is pulled out from ceiling voids into the main room space and sprays gas fire extinguishing agent.

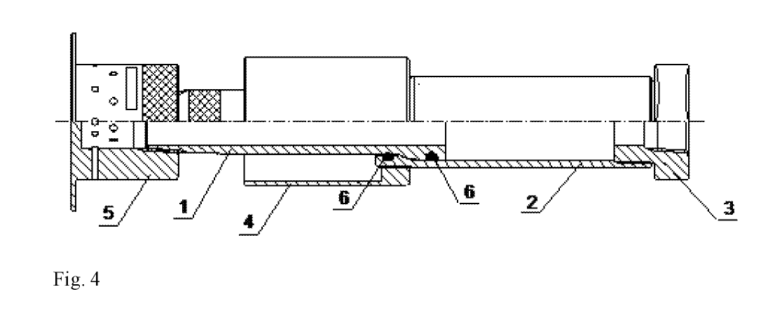

The subject invention (Variant 2, FIGS. 3, 4) includes the sprinkler case 2 in which the nipple rod 1 is installed. A groove for sealing O-ring 6 is in the sprinkler case 2 and in the nipple rod case 1. The sealing O-rings provide tightness and joint mobility the rod and the case relative to each other. The nipple rod is of variable outer diameter (OD). On the one side a rod is tapered and ended with a connection thread, on the other side it is extended that allows it to be blocked when moving to limit position. In its turn the case 2 has the opening of variable diameter for moving a nipple rod inside the case. A cover 3 is secured to the sprinkler case for closing the nipple rod in the sprinkler case. Thread in the cover 3 is provided for connection to the distributive pipe of the gas fire suppression system. A protective case 4 is secured to the sprinkler case from opposite side. A sprinkler tip 5 is secured to the connection thread of the nipple rod 1.

The subject device operates as follows.

The sprinkler in closed position is secured to the distributive pipe by means of connection thread on the cover 3. In this position the nipple rod 1 is in top limit position in the sprinkler case 2 and rests against the cover 3. Wherein the rod is kept in the closed position by means of the two sealing O-rings 6. The protective cap 4 in closed (duty) position blocks outlets of the sprinkler 5, creating hermetically sealed space. When the gas fire suppression system starts overpressure is generated in the distributive pipeline volume. Pressure rise inside the sprinkler results to moving the nipple rod 1 inside the case to lower limit position. Thus the sprinkler proceeds from closed (duty) position to extended (working) position. The sprinkler is pulled out from ceiling voids into the main room space and sprays gas fire extinguishing agent.

Thus the analysis results and data of the prototype model tests confirm the said technical result of the subject invention: achievement of high fire suppression efficiency due to uniform distribution of gas fire extinguishing agent in the room space under air compressed pressure in the pipeline, and the ready-to-work products spray gas fire extinguishing agent in a protected area, and also an opportunity of concealed installation of the device in the premises with false ceilings or technical ceiling voids.

Design of the products provides flexible sealed connection for extending the nipple rod from the sprinkler case, wherein the case operates as the guide for extending the nipple and as the retainer in limit working positions of the sprinkler.

The present invention allows to install the fire suppression systems in the museums, picture galleries and other cultural objects with high requirements to the interior of premises. This invention also allows to hide the fact that the premise is protected with the fire suppression system from outsiders and external persons.

The concealed extended sprinklers for the gas fire suppression systems can be applied simultaneously with each other (Variant 1 with Variant 2).

The subject invention is new as all set of cumulative features is unknown from previous technical level mentioned in corresponding section of the description.

The subject technical decision is of inventive level as for the expert it do not follow from the prior art clearly.

It is industrially applicable in relation to fire fighting technical equipment, namely to an element of the gas fire extinguishing systems for fire suppression in the miscellaneous premises.

What is claimed is:

1. A concealed extending sprinkler for gas fire suppression systems, mounted on a distributive pipe of the gas fire suppression system and comprising a sprinkler case with discharge outlets and a cover, characterized in that a nipple rod is installed in the sprinkler case, a groove in the sprinkler case and in a nipple rod case is designed for O-ring sealing, the nipple rod is of variable OD (outer diameter), on the one side the rod is tapered and ended with a connection thread, on another side it is extended, wherein in its turn the case has an opening of variable diameter providing moving the nipple rod inside the nipple rod case, the sprinkler case is extended outside, the cover is secured to the sprinkler case, connection tightness between the cover and the sprinkler case is provided by a sealing gasket.

2. A concealed extending sprinkler for gas fire suppression systems, mounted on a distributive pipe of the gas fire suppression system and comprising a sprinkler case with discharge outlets and a cover, characterized in that a nipple rod is installed in the sprinkler case, a groove in the sprinkler case and in a nipple rod case is designed for O-ring sealing, the nipple rod is of variable OD (outer diameter), on the one side the rod is tapered and ended with a connection thread, on another side it is extended, wherein in its turn the nipple rod case has an opening of variable diameter providing moving the nipple rod inside the nipple rod case, a cover is secured to the sprinkler case for closing the nipple rod in the sprinkler case, the thread in the cover is provided for connection to the distributive pipe of the gas fire suppression system, a protective cap is secured to the sprinkler case from an opposite side, the sprinkler is secured to the connection thread on a nipple rod.
